(19) United States
(12) Patent Application Publication
(10) Pub. No.: US 2017/0076289 A1
(43) Pub. Date: Mar. 16, 2017

(54) Cross Issuer Cardholder Decline Prevention Method and Apparatus

(71) Applicant: MasterCard International Incorporated, Purchase, NY (US)

(72) Inventor: Christine Brundage, Jacksonville, FL (US)

(21) Appl. No.: 14/850,832

(22) Filed: Sep. 10, 2015

(51) Int. Cl. G06Q 20/40

(52) U.S. Cl. CPC G06Q 20/409; G06Q 20/4018

(57) ABSTRACT

A system, method, and computer-readable storage medium to alert payment card issuers of anticipated cardholder travel and to identify whether cardholder transactions are taking place within the anticipated cardholder travel region.

### BACKGROUND

Field of the Disclosure

Aspects of the disclosure relate in general to financial services. Aspects include an apparatus, system, method and computer-readable storage medium to alert payment card issuers of anticipated cardholder travel and to identify whether cardholder transactions are taking place within the anticipated cardholder travel region.

Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

Payment cards also help reduce the risk of loss from theft when carrying large amounts of currency. Stolen payment cards are easily cancelled, which reduces the potential loss by a cardholder.

Payment card fraud is a wide-ranging term for theft and fraud committed using or involving a payment card as a fraudulent source of funds in a transaction. Payment card fraud includes obtaining goods and services without paying, or to obtain unauthorized funds from a payment card account. Because travel spending is out of pattern, payment card issuers are more likely to decline transactions when a cardholder is traveling away from their usual locale. Currently, for each of their payment cards, cardholders contact each payment card issuer to alert the issuer of anticipated travel.

### SUMMARY

Embodiments include a system, device, method and computer-readable medium to alert payment card issuers of anticipated cardholder travel and to identify whether cardholder transactions are taking place within the anticipated cardholder travel region.

In one embodiment, a system comprises a network interface and a processor. The network interface receives a cardholder travel registration. The cardholder travel registration includes a first cardholder identifier of a first payment card associated with a customer, an anticipated travel date, and an anticipated travel location. The processor uses the first cardholder identifier to retrieve a second cardholder identifier of a second payment card associated with the cardholder from a database record associated with the cardholder from a database stored on a non-transitory computer-readable storage medium. The processor determines a first issuer of the first payment card. The processor determines a second issuer of the second payment card. The network interface transmits to the first issuer a first notification message including the first cardholder identifier, the anticipated travel date, and the anticipated travel location. The network interface transmits the second issuer a second notification message including the second cardholder identifier, the anticipated travel date, and the anticipated travel location.

### BRIEF DESCRIPTION OF THE DRAWINGS

FIG. 1 is a block diagram illustrating a system to alert payment card issuers of anticipated cardholder travel and to identify whether cardholder transactions are taking place within the anticipated cardholder travel region.

FIG. 2 is an expanded block diagram of an exemplary embodiment of a server architecture of a payment processor embodiment configured to alert payment card issuers of anticipated cardholder travel and to identify whether cardholder transactions are taking place within the anticipated cardholder travel region.

FIG. 3 illustrates a method to store anticipated cardholder travel and/or allow payment card issuers access to anticipated cardholder travel information.

FIG. 4 depicts a process to identify whether cardholder transactions are taking place within an anticipated cardholder travel region.

### DETAILED DESCRIPTION

One aspect of the disclosure includes the realization that the current method of reporting anticipated travel to each individual issuer is burdensome and inconvenient to cardholders. Consequently, many cardholders fail to alert issuers of their anticipated travel.

Another aspect of the disclosure includes the understanding that cardholders are much more likely to report anticipated travel when it is convenient for them to do so.

A further aspect of the disclosure includes the realization that a system and service to notify multiple issuers of anticipated cardholder travel would decrease the likelihood of a preemptive payment card transaction decline by an issuer, and would assist in reducing payment card fraud.

The systems and processes are not limited to the specific embodiments described herein. In addition, components of each system and each process can be practiced independently and separately from other components and processes described herein. Each component and process also can be used in combination with other assembly packages and processes.

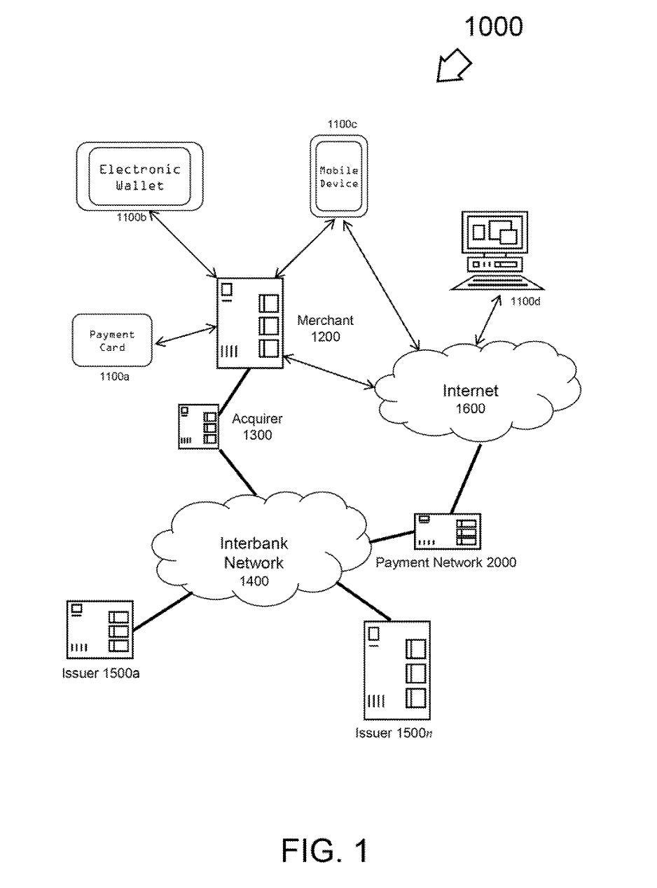

FIG. 1 is a block diagram 1000 illustrating a financial transaction using a payment card payment system configured to alert payment card issuers of anticipated cardholder travel and to identify whether cardholder transactions are taking place within the anticipated cardholder travel region.

It is understood that the anticipated travel notification may occur at a payment network or an independent third party. For sake of example only, the present disclosure will describe a payment network-based system, such as the payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network 1400 operated by MasterCard International Incorporated linking debit and payment cards to a network of ATMs throughout the world. Maestro is a multi-national debit card service owned by MasterCard International Incorporated.

In a financial payment system 1000, a financial institution called the “issuer” 1500 issues a payment card to a consumer, who uses payment card 1100a to tender payment for a travel purchase from a merchant 1200 or withdraw cash from an Automated Teller Machine. In addition to payment cards 1100, it is understood by those familiar with the art that the process herein applies equally to electronic wallets 1100b, mobile devices 1100c (such as key fobs, mobile phones, tablet computers, and the like), or computers 1100d, connected to merchant 1200 via a mobile telephone network (not shown) or the internet 1600. There may be a plurality of issuers 1500a-n assigned to the respective payment cards 1100a.

In one example, a cardholder presents the payment card to a point-of-sale device at a merchant 1200. In another example, cardholder may transact with merchant 1200 via a mobile telephone network or the Internet 1200 in an e-commerce transaction.

The merchant 1200 is affiliated with a financial institution. This financial institution is usually called the “merchant bank,” “acquiring bank,” “acquirer bank” or “acquirer” 1300. When a payment card 1100a is tendered at a merchant 1200, the merchant 1200 electronically requests authorization from the acquirer 1300 for the amount of the purchase. The request is performed electronically with the consumer's account information from the magnetic stripe on the payment card or for CHIP enabled payment cards, via the computer chip imbedded within the payment card 1100a. The account information and transaction information are forwarded to transaction processing computers of the acquirer 1300. Alternatively, an acquirer 1300 may authorize a third party to perform transaction processing on its behalf. In this case, the merchant 1200 will be configured to communicate with the third party. Such a third party is usually called a “merchant processor” or an “acquiring processor.”

Using a payment network 2000, the computers of the acquirer 1300 or the merchant processor will communicate via an interbank network 1400 authorization message or PIN network with the computers of the issuer 1500 to determine whether the consumer's account is in good standing and whether the transaction is likely to be fraudulent. In some embodiments, payment network 2000 scores the financial transaction and passes the score along with the transaction information to the issuer 1500. Fraud scoring refers to an indication, or likelihood, that a payment transaction is fraudulent. In one fraud scoring system embodiment, the payment network 2000 provides a number back to the issuer 1500 between zero and 1,000, which translates into zero and 100 percent, in tenths of percentage points. To provide fraud scoring capability, payment network 2000 may provide and market various different fraud scoring products. Issuer 1500 generally selects one of products to provide cardholders with fraud scoring.

In other embodiments, where travel is not factored into fraud scoring, the travel information is conveyed to issuer 1500 for their analysis and approval of the transaction.

When a request for authorization is accepted, the available credit balance of cardholder's account is decreased, and a payment is later made to merchant 1200 via acquirer 1300.

After a transaction is captured, the transaction is settled between the merchant 1200, the acquirer 1300, and the issuer 1500. As described herein, the term “payment card” includes cards such as credit cards, charge cards, and debit cards, but also includes any other devices that may hold payment account information, such as mobile phones, personal digital assistants (PDAs), cloud-based accounts, cashless payment devices/methods, and key fobs. Payment accounts may include credit, debit, savings, checking, money-market accounts or the like.

In instances where a cardholder anticipates future travel, the cardholder may contact payment network 2000 with that information. The communication may occur via a personal computer 1100d and Wide Area Network (WAN) such as the Internet 1600, via a mobile application running on a mobile device 1100c, or by telephone for example. The communication includes at least one payment card Primary Account Number (PAN) associated with the cardholder, and cardholder travel itinerary information such as dates of travel, and location of intended travel. Payment network 2000 uses the Primary Account Number information to contact the payment card issuer 1500 to convey to the issuer of the dates and location of intended travel. Additionally, payment network 2000 may then receive all the other payment cards issued to the cardholder, and then contact the respective issuers 1500 of those payment cards.

Additionally, once the payment network 2000 is aware of the anticipated cardholder travel dates, the payment network 2000 can identify whether cardholder transactions are taking place within the anticipated cardholder travel region, and factor the travel location more accurately within the transaction approval decision.

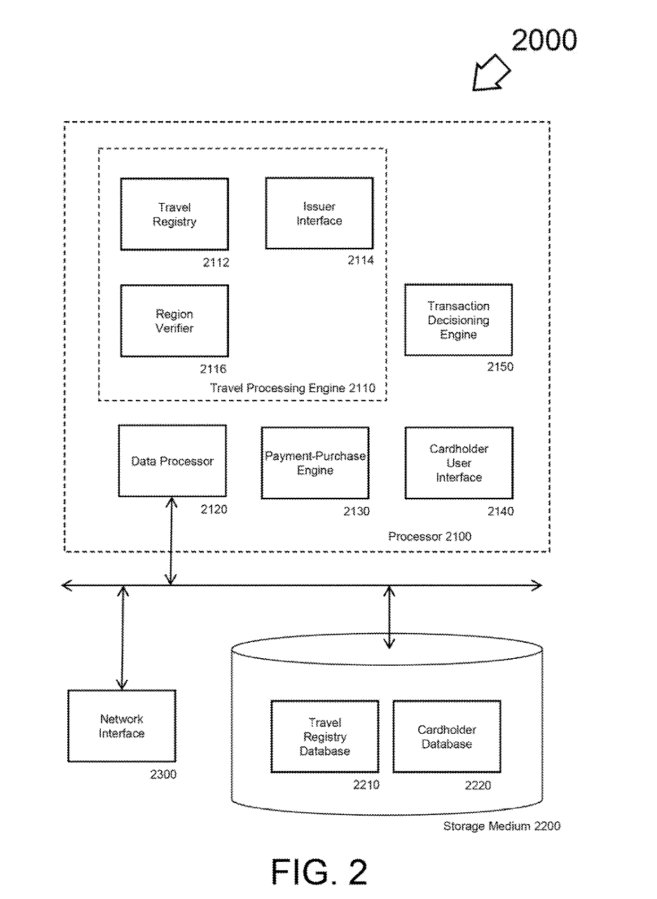

Embodiments will now be disclosed with reference to a block diagram of an exemplary payment network server of FIG. 2, configured to alert payment card issuers of anticipated cardholder travel and to identify whether cardholder transactions are taking place within the anticipated cardholder travel location, constructed and operative in accordance with an embodiment of the present disclosure. While the embodiment shown in FIG. 2 indicates that the payment server resides in the payment network 2000, it should be understood by those familiar with the art that a payment server may also exist at an issuer 1500, at a travel booking system, at a credit reporting agency, or the like.

Payment server may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a travel processing engine 2110, payment-purchase engine 2130, cardholder user interface 2140, transaction decisioning engine 2150, and a data processor 2120.

Data processor 2120 interfaces with storage medium 2200 and network interface 2300. The data processor 2120 enables processor 2100 to locate data on, read data from, and writes data to, these components.

Payment-purchase engine 2130 performs payment and purchase transactions, and may do so in conjunction with travel processing engine 2110.

Cardholder user interface 2140 enables cardholders communicating over the Internet 1600, to transmit a Primary Account Number and anticipated travel itinerary information to travel processing engine 2110. In some embodiments, cardholder user interface 2140 is a World Wide Web (WWW or “web”) based web page. In other embodiments, cardholder user interface 2140 is an application program interface (API) that allows a mobile application running on a mobile device 1100 to communicate with the travel processing engine 2110.

Transaction decisioning engine 2150 is the structure that applies fraud decisioning to a payment card transaction.

Travel processing engine 2110 is the structure that receives anticipated cardholder travel itineraries, determines whether a financial transaction is occurring at the anticipated location and travel dates, and informs issuers of the anticipated travel. Travel processing engine 2110 may further comprise: a travel registry 2112, an issuer interface 2114 and a region verifier 2116.

Travel registry 2112 records and tracks anticipated future travel by a cardholder using a travel registry database 2210.

Issuer interface 2114 is a structure configured to communicate information to an issuer regarding anticipated travel by the cardholder. Issuer interface 2114 is also the structure that determines other payment cards that are issued to a cardholder and may store its cardholder data in a cardholder database 2220.

Region verifier 2116 works in conjunction with transaction decisioning engine 2150 to factor the originating location of a payment card transaction and the anticipated travel by the cardholder into transaction fraud scoring.

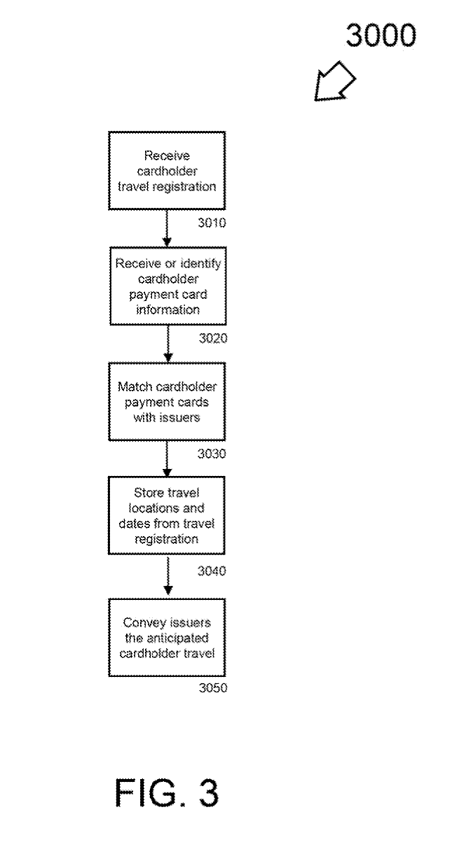

The functionality of all the travel processing engine 2110 structures is elaborated in greater detail in FIG. 3.

These structures may be implemented as hardware, firmware, or software encoded on a computer readable medium, such as storage medium 2200. Further details of these components are described with their relation to method embodiments below.

Non-transitory computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a travel registry database 2210, and a cardholder database 2220. Issuer interface 2114 may store cardholders' payment cards in a cardholder database 2220; in some embodiments, cardholder database 2220 may also store cardholder telephone numbers and electronic mail addresses as well as a cardholder spending profile, all with the appropriate notice and consent of the cardholder, as may be required under applicable law. Additionally, travel registry database 2210 may store data related to anticipated cardholder travel, including dates and intended locations. It is understood by those familiar with the art that one or more of these databases 2210-2220 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment server to communicate with merchant 1200 and issuer 1500.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

Embodiments create a spend-derived profile to anticipate cardholder travel to a destination. FIG. 3 illustrates a process 3000 to alert payment card issuers of anticipated cardholder travel, constructed and operative in accordance with an embodiment of the present disclosure. It is understood by those familiar with the art that process 3000 may be a real time process. Furthermore, it is understood that process 3000 or variations thereof may occur at an issuer 1500, at a third-party service, or at a payment network 2000. For the sake of example only, this disclosure will discuss a payment network 2000 embodiment.

At block 3010, cardholder user interface 2140 receives a travel registration from a cardholder's telephone, mobile device 1100c, or personal computer 1100d. The travel registration is a communication received electronically via a network interface 2300, and includes cardholder payment card information from at least one payment card issued to the cardholder, and a travel itinerary. Embodiments use standard industry security authentication protocols to verify that the travel registration was sent by the cardholder. The cardholder payment card information may be a Primary Account Number and expiration date for a payment card issued to the cardholder, for example. Other embodiments may also ask for a Card Verification Code (CVC), also known as a card security code. The card expiration date or Card Verification Code may be used to verify the travel registration was sent by the cardholder. The travel itinerary includes anticipated dates of travel, anticipated locations for the anticipated dates of travel as well as contact information during the anticipated dates of travel. For example, a cardholder mobile device may send a cardholder registration stating that the cardholder has a payment card with a specific Primary Account Number, and that the cardholder intends to be in Vienna, Austria on November 3^{rd}.

At block 3020, issuer interface 2114 of the travel processing engine 2110 either receives or identifies the cardholder based on the cardholder payment card information by searching the cardholder database 2220, retrieving a list of other known payment cards issued to the cardholder. Further, at block 3030, issuer interface 2114 matches each of the payment cards with their issuer 1500.

At block 3040, travel registry 2112 stores the provided anticipated traveler itinerary information in a travel registry database 2210.

The relevant issuers are conveyed the impending cardholder travel, along with a cardholder identifier (such as a Primary Account Number), and the dates and locations of the anticipated travel, block 3050.

Once informed, the issuer 1500 may factor the dates and locations of the anticipated cardholder travel in their approval or denial of cardholder transactions.

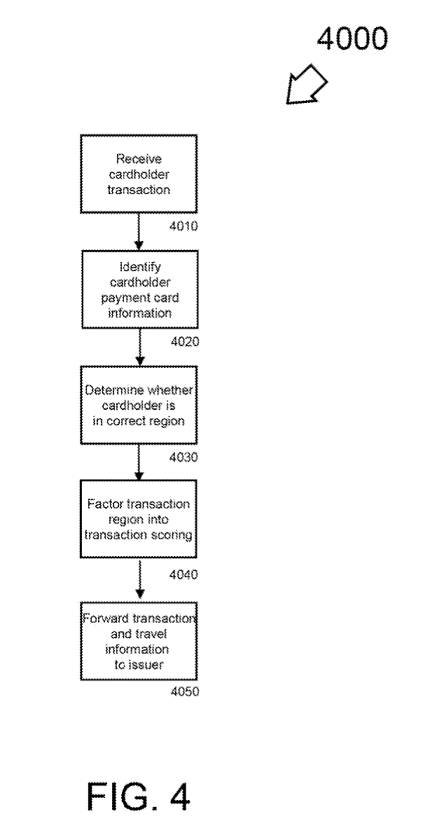

FIG. 4 illustrates an authorization process 4000 to identify whether cardholder transactions are taking place within the anticipated cardholder travel region, constructed and operative in accordance with an embodiment of the present disclosure. It is understood by those familiar with the art that process 4000 is a real time process.

At block 4010, payment network 2000 receives a cardholder financial transaction message via the network interface. The financial transaction message includes a cardholder identifier, transaction type, a transaction amount, and merchant location. The cardholder identifier may be a Primary Account Number of a payment card. The transaction type is an indicator of the type of transaction, such as a credit, or debit transaction. The transaction amount is the purchase amount. A merchant location is an identifier that indicates the merchant 1200 at which the transaction is taking place; often, the merchant location can be used to determine which store the transaction is taking place. Based on the cardholder identifier, the cardholder is determined by the travel registry 2112, which retrieves anticipated travel information from the travel registry database 2210, block 4020. The anticipated travel information includes an anticipated travel location and dates for the anticipated travel.

The region verifier 2116 determines the transaction location based on the merchant location, and compares the transaction location to the reported anticipated travel location, to determine whether the cardholder is in the correct region, block 4030. The comparison may be based on distance (such as radius from anticipated travel location), zip-code, city, county, state, province, country or region. For example, if the cardholder anticipated travel location reports that the cardholder will be in Austria in a specific time period, the comparison may encompass cities within Austria, such as Salzburg and Vienna. Similarly, if the cardholder anticipated travel location is Vienna, the comparison could be in the Vienna metropolitan area, distance from Vienna, country, or other region.

The transaction region is factored into the transaction scoring by the transaction decisioning engine 2150, block 4040.

The transaction and the resulting transaction score is forwarded to the issuer by the network interface 2300, block 4050.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, a cardholder travel registration, the cardholder travel registration including a first cardholder identifier of a first payment card associated with a customer, an anticipated travel date, and an anticipated travel location;
using, with a processor, the first cardholder identifier to retrieve a second cardholder identifier of a second payment card associated with the cardholder from a database record associated with the cardholder from a database stored on a non-transitory computer-readable storage medium;
determining a first issuer of the first payment card with the processor;
determining a second issuer of the second payment card with the processor;
transmitting to the first issuer, via the network interface, a first notification message including the first cardholder identifier, the anticipated travel date, and the anticipated travel location; and,
transmitting to the second issuer, via the network interface, a second notification message including the second cardholder identifier, the anticipated travel date, and the anticipated travel location.

2. The processing method of claim 1, wherein the cardholder travel registration further includes either a Card Verification Code or expiration date of the first payment card.

3. The processing method of claim 2, further comprising:
verifying the cardholder with either the Card Verification Code or the expiration date of the first payment card.

4. The processing method of claim 3, wherein first cardholder identifier is a first Primary Account Number.

5. The processing method of claim 4, wherein second cardholder identifier is a second Primary Account Number.

6. The processing method of claim 5, further comprising:
storing the anticipated travel date and the anticipated travel location in the database record associated with the cardholder.

7. A system comprising:
a network interface configured to receive a cardholder travel registration, the cardholder travel registration including a first cardholder identifier of a first payment card associated with a customer, an anticipated travel date, and an anticipated travel location;
a processor configured to use the first cardholder identifier to retrieve a second cardholder identifier of a second payment card associated with the cardholder from a database record associated with the cardholder from a database stored on a non-transitory computer-readable storage medium, configured to determine a first issuer of the first payment card with the processor, configured to determine a second issuer of the second payment card with the processor;
wherein the network interface is further configured to transmit to the first issuer a first notification message including the first cardholder identifier, the anticipated travel date, and the anticipated travel location; and,
wherein the network interface is further configured to transmit to the second issuer a second notification message including the second cardholder identifier, the anticipated travel date, and the anticipated travel location.

8. The system of claim 7, wherein the cardholder travel registration further includes either a Card Verification Code or expiration date of the first payment card.

9. The system of claim 8, wherein the processor is further configured to verify the cardholder with either the Card Verification Code or the expiration date of the first payment card.

10. The system of claim 9, wherein first cardholder identifier is a first Primary Account Number.

11. The system of claim 10, wherein second cardholder identifier is a second Primary Account Number.

12. The system of claim 11, wherein the non-transitory computer-readable storage medium is configured to store the anticipated travel date and the anticipated travel location in the database record associated with the cardholder.

13. A non-transitory computer readable medium encoded with data and instructions, when executed by a computing device the instructions causing the computing device to:
receive, via a network interface, a cardholder travel registration, the cardholder travel registration including a first cardholder identifier of a first payment card associated with a customer, an anticipated travel date, and an anticipated travel location;
use, with a processor, the first cardholder identifier to retrieve a second cardholder identifier of a second payment card associated with the cardholder from a database record associated with the cardholder from a database stored on the non-transitory computer-readable storage medium;
determine a first issuer of the first payment card with the processor;
determine a second issuer of the second payment card with the processor;
transmit to the first issuer, via the network interface, a first notification message including the first cardholder identifier, the anticipated travel date, and the anticipated travel location; and,
transmit to the second issuer, via the network interface, a second notification message including the second cardholder identifier, the anticipated travel date, and the anticipated travel location.

14. The non-transitory computer-readable storage medium of claim 13, wherein the cardholder travel registration further includes either a Card Verification Code or expiration date of the first payment card.

15. The non-transitory computer-readable storage medium of claim 14, the instructions causing the computing device to:
verify the cardholder with either the Card Verification Code or the expiration date of the first payment card.

16. The non-transitory computer-readable storage medium of claim 15, wherein first cardholder identifier is a first Primary Account Number.

17. The non-transitory computer-readable storage medium of claim 16, wherein second cardholder identifier is a second Primary Account Number.

18. The non-transitory computer-readable storage medium of claim 17, the instructions causing the computing device to:
store the anticipated travel date and the anticipated travel location in the database record associated with the cardholder.
